(19) United States
(12) Patent Application Publication
(10) Pub. No.: US 2026/0336109 A1
(43) Pub. Date: Oct. 29, 2026

(54) ROBOT CONTROLLER

(71) Applicant: KAWASAKI JUKOGYO KABUSHIKI KAISHA, Kobe-shi (JP)

(72) Inventors: Takamasa HATTORI, Kobe-shi (JP); Hiroki MARUBAYASHI, Kobe-shi (JP); Katsuhisa YAMAMOTO, Kobe-shi (JP)

(73) Assignee: KAWASAKI JUKOGYO KABUSHIKI KAISHA, Kobe-shi (JP)

(21) Appl. No.: 19/575,195

(22) Filed: Mar. 23, 2026

(30) Foreign Application Priority Data
Mar. 21, 2025 (JP) 2025-047529

(51) Int. Cl. B25J 9/16; B25J 19/00

(52) U.S. Cl. CPC B25J 9/1653; B25J 9/1674; B25J 19/0004; B25J 19/0025

(57) ABSTRACT

The robot controller includes: a drive circuit that receives an operation command from a control circuit and outputs a drive command to move a robot; a first monitoring circuit that monitors the robot based on sensor output and, when an abnormality of the robot is detected, outputs a stop command to stop the robot; and a mount on which a second monitoring circuit different from the first monitoring circuit is removably mounted.

### CROSS-REFERENCE TO RELATED APPLICATION

This application claims priority to Japanese Patent Application No. 2025-47529 filed on Mar. 21, 2025, the entire disclosure of which is incorporated herein by reference.

### BACKGROUND

A conventional robot controller has a function to monitor whether any abnormality has occurred in a robot system. When a monitoring unit of the robot controller detects an abnormality in the robot system, the monitoring unit operates a power shutoff unit such that a motor drive unit and an external power supply are electrically disconnected.

### SUMMARY

The capability of the monitoring unit of a robot controller varies depending on the robot or robot system controlled by the robot controller. For example, as the number of monitoring targets increases, the monitoring unit is to have a higher level of capability.

In a conventional robot controller, increasing the capability of the monitoring unit has involved replacing the processor of the monitoring unit with one having higher processing capability. In other words, separate monitoring units have been provided for different robots or robot systems controlled by the robot controller.

The technology disclosed herein relates to a robot controller. The robot controller includes: a drive circuit that receives an operation command from a control circuit and outputs a drive command to move a robot; a first monitoring circuit that monitors the robot based on sensor output and, when an abnormality of the robot is detected, outputs a stop command to stop the robot; and a mount on which a second monitoring circuit different from the first monitoring circuit is removably mounted.

### BRIEF DESCRIPTION OF THE DRAWINGS

FIG. 1 shows a robot controlled by a robot controller.

FIG. 2 is a block diagram of the robot controller.

FIG. 3 shows a schematic structure of an enclosure of the robot controller.

FIG. 4 shows a signal flow when a monitoring board of a first drive board outputs a stop signal.

FIG. 5 shows a signal flow when a monitoring board of a second drive board outputs a stop signal.

FIG. 6 shows a signal flow when a stop switch is pressed.

FIG. 7 is a block diagram of the robot controller on which two or more monitoring boards are mounted.

FIG. 8 is a flowchart of a control procedure for monitoring the robot by the robot controller.

FIG. 9 shows a signal flow when a monitoring board of a first drive board outputs a stop signal in a robot controller according to a modification.

FIG. 10 is a block diagram of a robot controller according to another modification.

### DETAILED DESCRIPTION OF THE DRAWINGS

An embodiment of a robot controller and a robot control method will now be described with reference to the drawings. The robot controller and the robot control method described herein are merely illustrative examples.

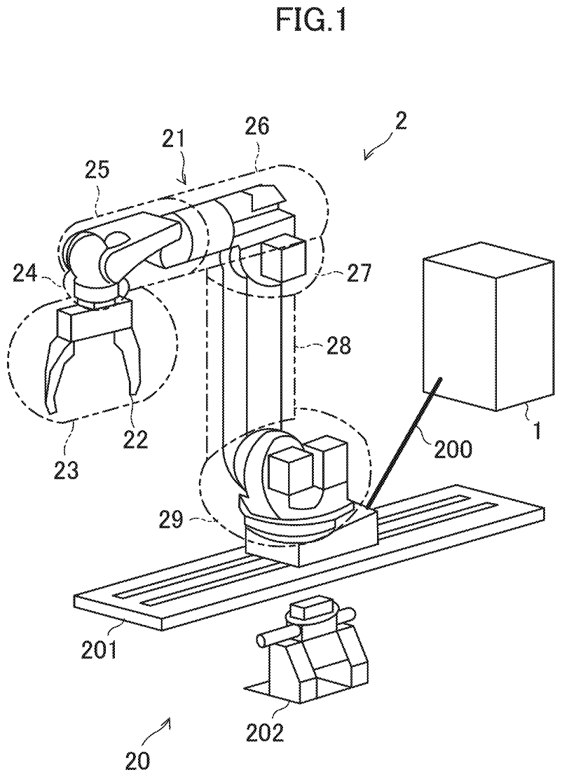

FIG. 1 illustrates a robot 2 controlled by a robot controller 1. The robot 2 shown in FIG. 1 is an articulated robot. More specifically, the robot 2 in FIG. 1 is a six-axis vertical articulated robot. The robot 2 is a so-called industrial robot and, for example, transfers workpieces.

The robot to which the technology disclosed herein is applicable is not limited to articulated robots. The technology disclosed herein is applicable to robots having various structures. The work performed by the robot 2 is not limited to transferring workpieces. The robot 2 may perform various kinds of work. The robot 2 is not limited to industrial robots.

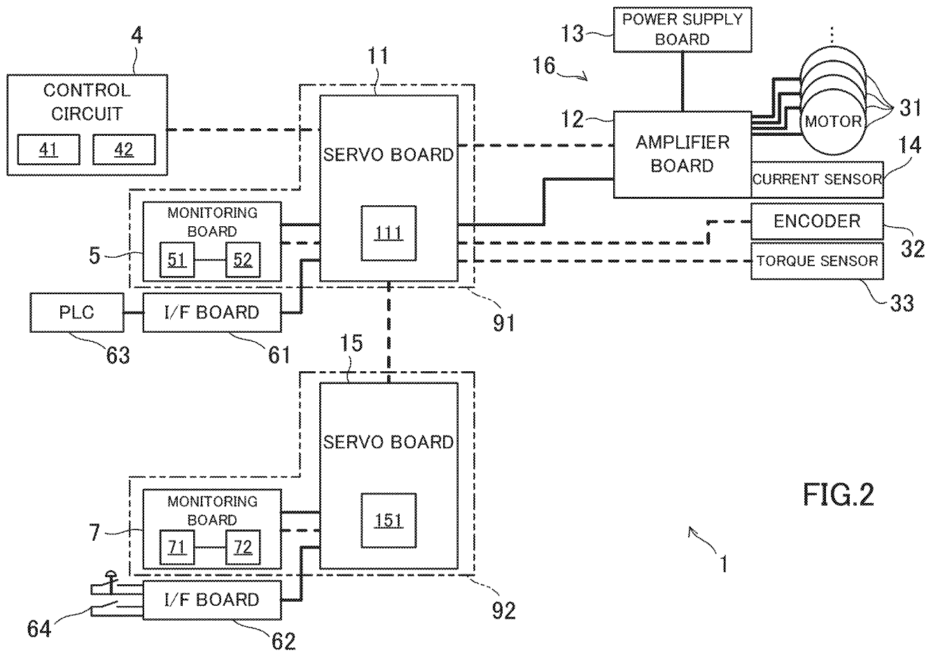

The robot 2 includes an arm 21. The arm 21 includes links connected to each other. The arm 21 supports an end effector 22. The robot 2 includes actuators that move the arm 21 and the end effector 22. As shown in FIG. 2, each actuator includes an electric motor 31. Each electric motor 31 may be an AC servo motor whose rotating shaft rotates when supplied with three-phase AC power. Each electric motor 31 may alternatively be a servo motor with a brake.

The robot controller 1 controls the robot 2, or a robot system 20 including the robot 2 and peripheral devices of the robot 2. The robot controller 1 is electrically connected to the robot system 20 via a harness 200.

Examples of peripheral devices controlled by the robot controller 1 include a travel axis 201 that moves the robot 2, a workpiece positioner 202, and a workpiece locator. The peripheral devices are not limited to the travel axis 201, the workpiece positioner 202, or the workpiece locator. Other examples of peripheral devices include a turntable that turns the robot 2, a conveyor that conveys a workpiece to the robot 2, a device that processes a workpiece conveyed by the robot 2, and an aligner that aligns a substrate serving as a workpiece.

In the following description, the expression “the robot controller 1 controls the robot 2” may be used to encompass cases in which the robot controller 1 controls the robot system 20.

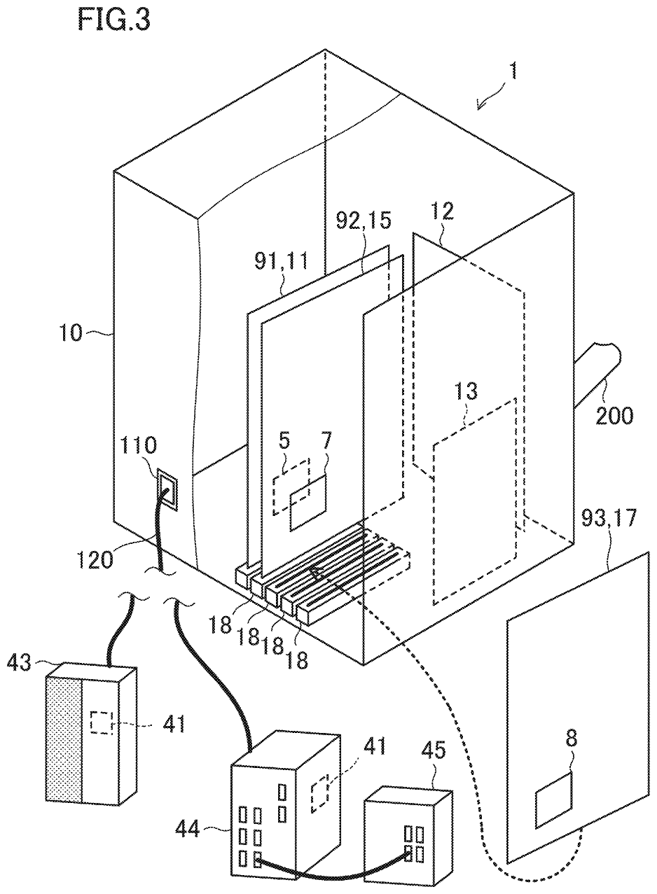

FIG. 2 is a block diagram of the robot controller 1. FIG. 3 schematically shows the structure of an enclosure 10 of the robot controller 1.

In FIG. 2, dashed lines indicate connections between elements via communication lines. A connection between elements via a communication line is a network connection using a particular protocol. The particular protocol is preferably, for example, a protocol with guaranteed real-time performance. A protocol with guaranteed real-time performance improves the accuracy of robot control. The particular protocol may be, for example, EtherCAT (registered trademark). Because EtherCAT is an open protocol, a general-purpose computer 44 can be easily connected to a servo board 11, described later. The particular protocol is not limited to EtherCAT.

Solid lines indicate connections between elements via electrical circuits. A connection between elements via an electrical circuit means that a voltage signal or a current signal is transmitted between the elements.

The robot controller 1 includes the servo board 11. The servo board 11 receives an operation command from a control circuit 4, described later, and outputs drive commands for the electric motors 31. As used herein, a “board” may include one or more printed circuit boards.

The servo board 11 includes a servo central processing unit (CPU) 111. The servo board 11 may include two or more servo CPUs 111. The servo board 11 may include a number of servo CPUs 111 corresponding to the number of electric motors 31 connectable to the robot controller 1.

The servo board 11 may include fewer servo CPUs 111 than the number of electric motors 31. The servo board 11 may include a single servo CPU 111. The single servo CPU 111 may correspond to all motion axes of the robot 2, for example, the electric motors 31 for all six axes. The single servo CPU 111 may correspond to the electric motors 31 of the peripheral devices 201 and 202 in addition to all motion axes of the robot 2.

The control circuit 4 is connected to the servo board 11 through communication. The connection between the control circuit 4 and the servo board 11 is a network connection using the particular protocol described above.

The control circuit 4 includes a main processor 41 and a memory 42. The main processor 41 calculates operation commands for the robot 2 or the peripheral devices 201 and 202 in accordance with software stored in the memory 42. The operation commands may include a position command, an actuator speed command, a torque command, or a combination of a position command, an actuator speed command, and a torque command. The control circuit 4 transmits the calculated operation commands to the servo board 11.

Various control circuits 4 can be connected to the servo board 11. The control circuit 4 may be a processor unit 43 connected to the robot controller 1, as shown in FIG. 3. The processor unit 43 is connected to a port 110 via a communication cable 120. The port 110 opens to the exterior of the enclosure 10 of the robot controller 1. The enclosure 10 of the robot controller 1 and the processor unit 43 may be integrated.

The control circuit 4 may be the general-purpose computer 44 connected to the robot controller 1. In that case, the computer 44, rather than the processor unit 43, is connected to the port 110 of the robot controller 1 via the communication cable 120.

The computer 44 is, for example, an industrial PC (IPC). The computer 44 may be a commercially available computer. The main processor 41 of the computer 44 may have higher processing capability than the main processor 41 of the processor unit 43. Higher processing capability of the main processor facilitates control of the robot 2 or a robot system 20 having a large number of controlled objects. The computer 44 is also suitable, for example, for controlling a social robot having more axes than an industrial robot.

In addition to the robot controller 1, a servo drive unit 45 may also be connected to the computer 44. The servo drive unit 45 may be, for example, a commercially available servo drive unit. The servo drive unit 45 may be used, for example, to drive peripheral devices of the robot 2.

The control circuit 4 may be a processor board housed in the enclosure 10 of the robot controller 1. The processor board may be connected to the servo board 11 via a connector within the enclosure 10. The processor unit 43 or the computer 44 may be connected via the port 110 to the robot controller 1 having the processor board.

The processor unit 43, the computer 44, and the processor board differ from each other in the processing capability of the main processor 41. As described above, the processing capability of the main processor 41 of the computer 44 may be higher than that of the main processor 41 of the processor unit 43. The processing capability of the main processor 41 of the processor unit 43 may be higher than that of the main processor 41 of the processor board. The control circuit 4 to be combined with the robot controller 1 is selected from the processor unit 43, the computer 44, and the processor board according to the specifications of the robot 2 or the robot system 20 to be controlled. The robot controller 1 is a highly scalable controller that can accommodate robot control ranging from lower-specification control to higher-specification control.

As shown in FIG. 2 or 3, the robot controller 1 includes an amplifier board 12. The amplifier board 12 is an example of an amplifier module. The amplifier board 12 is communicably connected to the servo board 11 via a communication line. The servo board 11 transmits drive commands for the electric motors 31 to the amplifier board 12 through the communication line.

The amplifier board 12 and the servo board 11 are connected to each other via an electrical circuit.

The amplifier board 12 includes inverter circuits, each including switching elements. The inverter circuits supply AC power to the electric motors 31. The amplifier board 12 includes a number of inverter circuits corresponding to the number of electric motors 31 connectable to the robot controller 1.

The robot controller 1 includes a power supply board 13. The power supply board 13 supplies power to the electric motors 31 through the amplifier board 12. The power supply board 13 is an example of a power supply module.

More specifically, in each inverter circuit of the amplifier board 12, the switching elements perform switching operations in accordance with drive commands from the servo board 11. Through the switching operations of the switching elements, power from the power supply board 13 is supplied to the electric motors 31 as three-phase AC power. The electric motors 31 are driven by the supplied power. As the electric motors 31 are driven, the robot 2 or the peripheral devices 201 and 202 operate.

The amplifier board 12 and the power supply board 13 form a power supply section 16 of the robot controller 1.

The amplifier board 12 includes a current sensor 14. The current sensor 14 outputs a signal corresponding to current supplied to the electric motors 31. The amplifier board 12 transmits a detected value of the current sensor 14 to the servo board 11 as a sensor output.

Encoders 32 are connected to the servo board 11. Each encoder 32 is included in a corresponding actuator of the robot 2. Each encoder 32 transmits a detected value corresponding to the rotation angle of a corresponding electric motor 31 to the servo board 11 as a sensor output.

Torque sensors 33 are also connected to the servo board 11. Each torque sensor 33 is included in a corresponding actuator of the robot 2. Each torque sensor 33 transmits a detected value corresponding to the torque of a corresponding axis of the robot 2 to the servo board 11 as a sensor output.

The output of the current sensor 14, the outputs of the encoders 32, and the outputs of the torque sensors 33 are used to monitor the robot 2 or the robot system 20.

The robot controller 1 includes a monitoring board 5. The monitoring board 5 is connected to the servo board 11 through communication. The monitoring board 5 is also connected to the amplifier board 12 via the servo board 11 through an electrical circuit.

The monitoring board 5 includes a first processor 51 and a second processor 52 in a redundant configuration. The monitoring board 5 monitors the robot 2 or the robot system 20 including the robot 2 and the peripheral devices. The monitoring board 5 is an example of the first monitoring circuit. The monitoring board 5 outputs a stop signal for stopping the robot 2 when an abnormality is detected. Monitoring by the monitoring board 5 will be described in detail later.

The monitoring board 5 may be stacked on the servo board 11. The servo board 11 including the monitoring board 5 is herein referred to as first drive board 91 (see also FIG. 3).

The robot controller 1 includes an interface (I/F) board 61. The I/F board 61 is connected to the servo board 11 via an electrical circuit. The servo board 11 electrically connects the I/F board 61 and the monitoring board 5 to each other.

An external module is connected to the I/F board 61. The external module is, for example, a programmable logic controller (PLC) 63 to which a detection device such as a laser scanner or a light curtain is connected. The detection device detects the robot 2 in operation and outputs a detection signal to the PLC 63. Upon receiving the detection signal, the PLC 63 outputs a stop signal for the robot 2 to the servo board 11 through the I/F board 61. The PLC 63 may also receive a signal from a switch that detects an open state of a safety fence provided in a work area of the robot 2, and may output, based on the signal from the switch, a stop signal for the robot 2 to the servo board 11 through the I/F board 61.

The robot controller 1 includes a second drive board 92. The second drive board 92 has the same structure as the first drive board 91.

The second drive board 92 includes a servo board 15. The servo board 15 is the same as the servo board 11 described above. The servo board 15 includes a servo CPU 151. The servo board 15 of the second drive board 92 is connected to the servo board 11 of the first drive board 91 through communication.

The second drive board 92 includes a monitoring board 7. The monitoring board 7 is stacked on the servo board 15. The monitoring board 7 and the servo board 15 are connected through communication and via an electrical circuit. The monitoring board 7 is connected to the servo board 15 in the same manner as the monitoring board 5 is connected to the servo board 11.

The monitoring board 7 includes a first processor 71 and a second processor 72 in a redundant configuration. The monitoring board 7 has the same function as the monitoring board 5. The monitoring board 7 is an example of the second monitoring circuit.

An I/F board 62 is connected to the servo board 15 via an electrical circuit. The servo board 15 electrically connects the I/F board 62 and the monitoring board 7 to each other.

A stop switch 64 is connected to the I/F board 62. The stop switch 64 is a manual switch operated by an operator. When the operator turns on the stop switch 64, the I/F board 62 outputs a stop signal for the robot 2 to the servo board 15.

An external module may be connected to the I/F board 62 via the PLC 63, and the stop switch 64 may be connected to the I/F board 61. The I/F board 61 or the I/F board 62 may be omitted.

As shown in FIG. 3, the enclosure 10 of the robot controller 1 includes mounts 18. Each of the drive boards 91 and 92 is removably mounted on a corresponding mount 18. The respective servo boards 11 and 15 of the drive boards 91 and 92 mounted on the mounts 18 are connected to each other through communication. The connection between the servo boards 11 and 15 may be a plug-and-socket connection.

The drive boards 91 and 92 are examples of modules each removably mounted on a corresponding mount 18. As used herein, a “module” may include a single printed circuit board, may include two or more printed circuit boards, or may include one or more printed circuit boards housed in an enclosure.

### Robot Monitoring

The robot controller 1 has, as safety functions, at least a position monitoring function, a force monitoring function, and an emergency stop function. The safety functions are not limited to these three functions. These safety functions are implemented by the monitoring boards 5 and 7.

The position monitoring function is a function to monitor whether the position of the robot 2 is within a permitted operating position range. When the position of the robot 2 falls outside the permitted operating position range, the robot controller 1 brings the robot 2 to a protective stop.

The force monitoring function is a function to monitor whether a force applied to the robot 2 is less than or equal to a permitted operating force. When the force applied to the robot 2 exceeds the permitted operating force, the robot controller 1 brings the robot 2 to a protective stop.

The emergency stop function is a function by which the robot controller 1 causes the robot 2 to make an emergency stop when an emergency stop signal is input by the operator.

The position monitoring function will be described in more detail. The robot controller 1 monitors the position of the robot 2 as the respective positions of monitoring models 23 to 29, as exemplified by long dashed double-short dashed lines in FIG. 1. When the position of any of the monitoring models 23 to 29 falls outside a permitted operating space, the robot controller 1 brings the robot 2 to a protective stop. The monitoring models 23 to 29 are examples of portions of the robot 2.

The servo board 11 receives sensor outputs from the encoders 32 and calculates current values of the angles or positions of the axes of the robot 2 by converting the detected values of the encoders 32, namely the rotation angles of corresponding electric motors 31, into angles or positions of corresponding axes of the robot 2. The servo board 11 transmits the current values of the angles or positions of the axes to the monitoring board 5 or the monitoring board 7.

The monitoring boards 5 and 7 calculate the positions of the monitoring models 23 to 29 based on the current values of the positions or the like received from the servo board 11, and detect that the position of any of the monitoring models 23 to 29 falls outside the permitted operating space. When the position of any of the monitoring models 23 to 29 falls outside the permitted operating space, the monitoring boards 5 and 7 output a stop signal (or a stop command described later).

In monitoring the position of the robot 2, the robot controller 1 may detect, based on the detected values of the encoders 32, that the angle or position of any of the axes of the robot 2 falls outside a predetermined permitted operating axis range.

The robot controller 1 also detects an operation abnormality of the robot 2 by comparing the drive commands transmitted from the servo board 11 to the amplifier board 12 with the detected values indicating the rotation angles of the electric motors 31 as detected by the encoders 32.

More specifically, the servo board 11 estimates the angles or positions of the axes based on the drive commands transmitted to the amplifier board 12, and transmits the estimated values of the positions or the like to the monitoring board 5 or the monitoring board 7.

The monitoring boards 5 and 7 calculate a difference between the estimated value of the position or the like of each axis received from the servo board 11 and the current value of the position or the like of that axis obtained based on the detected values of a corresponding encoder 32, and detect an operation abnormality of the robot 2 when any of the differences is greater than a preset threshold. When an operation abnormality is detected, the monitoring boards 5 and 7 output a stop signal (or a stop command).

The monitoring boards 5 and 7 each include redundant processors. The processors 51 and 52 of the monitoring board 5 perform calculations in parallel, and the processors 71 and 72 of the monitoring board 7 perform calculations in parallel. The two processors 51 and 52 each obtain the other processor's calculation result by outputting their own calculation results to each other. Likewise, the two processors 71 and 72 each obtain the other processor's calculation result by outputting their own calculation results to each other. Each of the processors 51 and 52 monitors the other processor's state by comparing its own calculation result with the other calculation result obtained from the other processor. Likewise, each of the processors 71 and 72 monitors the other processor's state by comparing its own calculation result with the other calculation result obtained from the other processor. When an abnormality is detected as a result of the monitoring, the monitoring boards 5 and 7 output a stop signal (or a stop command).

In the force monitoring function, the robot controller 1 calculates a force applied from outside to the robot 2 by using the sensor outputs of the current sensor 14, the encoders 32, and the torque sensors 33, and monitors whether the force applied to the robot 2 is less than or equal to the permitted operating force.

### Stopping the Robot by the Monitoring Boards

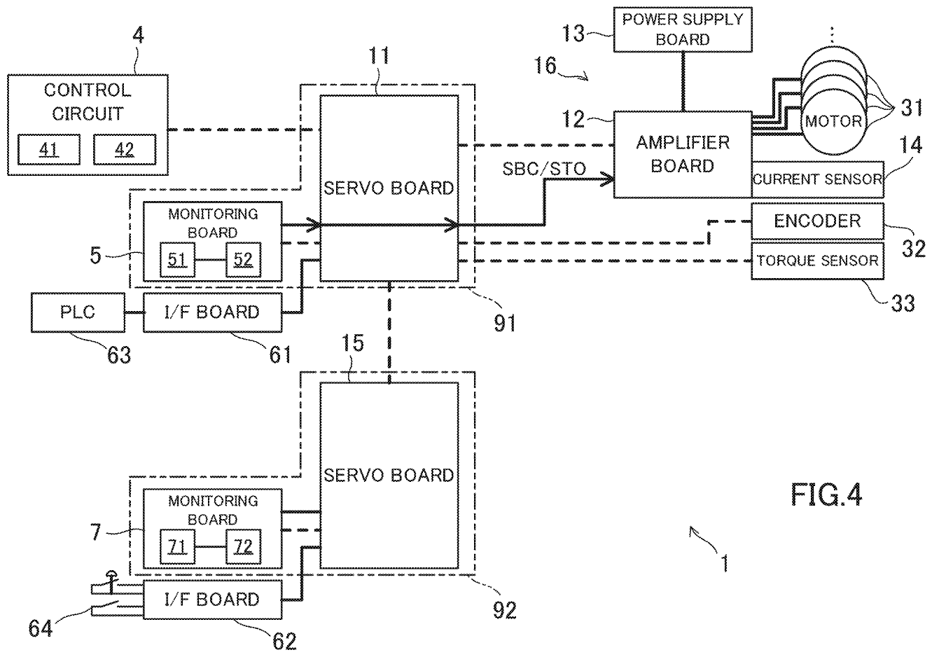

FIGS. 4 to 6 show signal or data flows when the monitoring board 5 or 7 outputs a stop signal. FIG. 4 shows a case where the monitoring board 5 of the first drive board 91 detects an abnormality. The monitoring board 5 outputs, as a stop signal, a Safe Brake Control (SBC) signal or a Safety Torque Off (STO) signal to the amplifier board 12 through an electrical circuit (see the solid arrows in FIG. 4). The stop signal output by the monitoring board 5 through the electrical circuit is a voltage signal or a current signal.

When the amplifier board 12 receives the SBC signal, it actuates the brakes of the electric motors 31. The electric motors 31 decelerate to a stop. When the amplifier board 12 receives the STO signal, it stops the switching operations of the switching elements of the inverter circuits. The amplifier board 12 cuts off power supply to the electric motors 31.

Operation of the robot 2 is stopped in response to the stop signal output by the monitoring board 5.

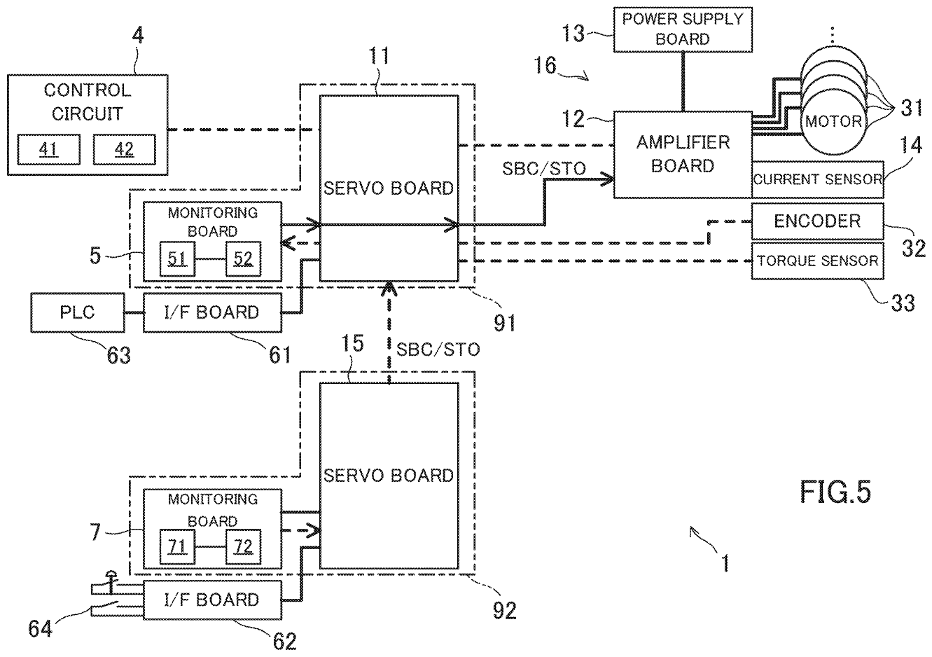

FIG. 5 shows a signal flow when the monitoring board 7 of the second drive board 92 detects an abnormality. As shown by the dashed arrows in FIG. 5, the monitoring board 7 outputs a stop command (SBC/STO) to the monitoring board 5 of the first drive board 91 through communication. The stop command output by the monitoring board 7 is not a voltage signal or a current signal, but information transmitted through communication.

Upon receiving the stop command, the monitoring board 5 outputs a stop signal (SBC/STO) to the amplifier board 12 through an electrical circuit, as shown by the solid arrows in FIG. 5. When the amplifier board 12 receives the stop signal, it actuates the brakes of the electric motors 31 or cuts off power supply to the electric motors 31 in the same manner as described above. Operation of the robot 2 is thus stopped.

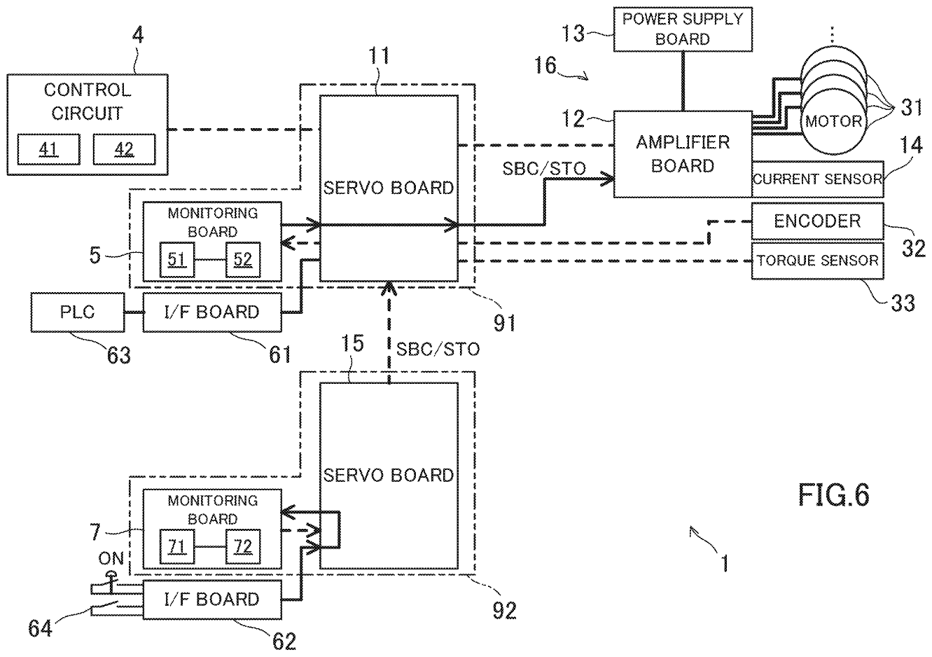

FIG. 6 shows a signal flow when the stop switch 64 is turned on. As shown by the solid arrows in FIG. 6, the I/F board 62 outputs a stop signal, and the stop signal is input to the monitoring board 7 through an electrical circuit. Upon receiving the stop signal, the monitoring board 7 outputs a stop command (SBC/STO) to the monitoring board 5 of the first drive board 91 through communication, as shown by the dashed arrows in FIG. 6. Upon receiving the stop command, the monitoring board 5 outputs a stop signal to the amplifier board 12 through an electrical circuit. When the amplifier board 12 receives the stop signal, it actuates the brakes of the electric motors 31 or cuts off power supply to the electric motors 31. Operation of the robot 2 is thus stopped.

### Expansion of Monitoring Boards

The robot controller 1 includes two monitoring boards: the monitoring board 5 of the first drive board 91 and the monitoring board 7 of the second drive board 92. The monitoring board 5 may monitor, for example, the positions of some of the monitoring models 23 to 29, and the monitoring board 7 may monitor the positions of the remaining monitoring models. The computational load on the monitoring boards 5 and 7 is high, and monitoring the positions of a large number of monitoring models with a single monitoring board 5 or 7 requires a processor having high processing capability. Distributing the task of monitoring the positions of the monitoring models 23 to 29 among multiple monitoring boards 5 and 7 allows the individual monitoring boards 5 and 7 to operate without relying on high processing capability. Combining two or more monitoring boards 5 and 7 enhances the overall monitoring capability of the robot controller 1.

The monitoring board 5 may monitor some of the axes of the robot 2 or the robot system 20, and the monitoring board 7 may monitor the remaining axes.

As described above, the robot controller 1 can accommodate robot control ranging from lower-specification control to higher-specification control. In higher-specification robot control, the number of monitoring models or axes to be monitored further increases. Therefore, the processing capability available from the two monitoring boards 5 and 7 may be insufficient.

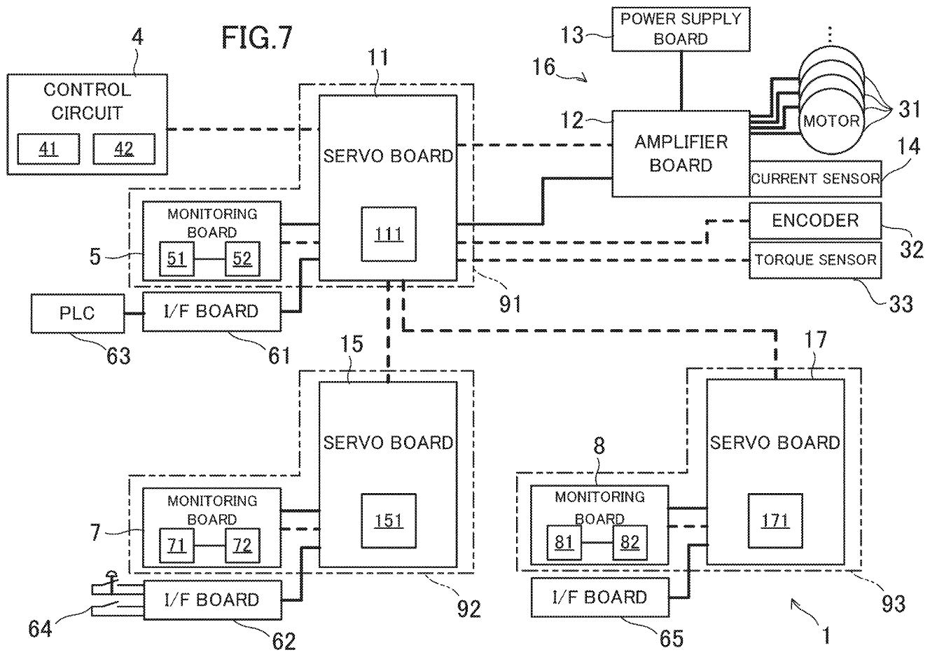

Accordingly, the robot controller 1 has a structure in which the number of monitoring boards can be easily increased or decreased. FIG. 7 shows the robot controller 1 with an additional monitoring board installed. The robot controller 1 includes a third drive board 93. The third drive board 93 has the same structure as the first drive board 91 and the second drive board 92.

The third drive board 93 includes a servo board 17. The servo board 17 is the same as the servo boards 11, 15 described above. The servo board 17 includes a servo CPU 171. The servo board 17 of the third drive board 93 is connected to the servo board 11 of the first drive board 91 through communication.

The third drive board 93 includes a monitoring board 8. As shown in FIG. 3, the monitoring board 8 is stacked on the servo board 17. The monitoring board 8 and the servo board 17 are connected through communication and via an electrical circuit. The monitoring board 8 is connected to the servo board 17 in the same manner as the monitoring board 5 is connected to the servo board 11.

The monitoring board 8 includes a first processor 81 and a second processor 82 in a redundant configuration. The monitoring board 8 has the same function as the monitoring boards 5 and 7. The monitoring board 8 is an example of the third monitoring circuit.

An I/F board 65 is connected to the servo board 17 via an electrical circuit. The I/F board 65 may be omitted.

As shown in FIG. 3, the enclosure 10 of the robot controller 1 includes the mounts 18. As shown by the dashed arrow in FIG. 3, the third drive board 93 is removably mounted on a corresponding mount 18. The servo board 17 of the third drive board 93 mounted on the mount 18 is connected to the servo board 11 of the first drive board 91 through communication. The robot controller 1 may include two or more drive boards 92 and 93.

The robot controller 1 has a structure in which the number of monitoring boards can be increased or decreased. The number of drive boards mounted on the mounts 18 of the robot controller 1 is selected according to the robot 2 or the robot system 20 to be controlled. Even in a case where the robot 2 or the robot system 20 to be controlled is of a higher specification, the robot 2 or robot system 20 can be monitored by distributing the monitoring task among multiple monitoring boards.

In a case where the robot 2 or the robot system 20 to be controlled is of a lower specification, the number of monitoring models or axes to be monitored is small. In that case, the monitoring board 7 and the second drive board 92 may be removed from the robot controller 1, and the monitoring board 5 may perform monitoring of the robot 2 or the robot system 20.

### Control Procedure of First Drive Board

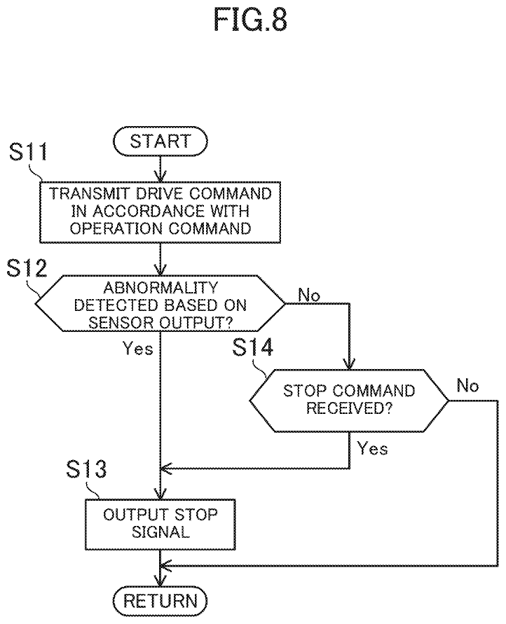

The flowchart of FIG. 8 shows a control procedure for the first drive board 91. In the flowchart of FIG. 8, modifications such as changing the order of steps, omitting some steps, or adding other steps are permissible.

First, in step S11 after the start, the servo board 11 of the first drive board 91 transmits a drive command to the amplifier board 12 through a communication line in accordance with an operation command from the control circuit 4.

In the following step S12, the monitoring board 5 of the first drive board 91 determines, based on sensor output, whether an abnormality has been detected. When an abnormality is detected, the monitoring board 5 outputs a stop signal to the amplifier board 12 through an electrical circuit in step S13.

When no abnormality is detected, the monitoring board 5 determines in step S14 whether a stop command has been received through communication from another monitoring board 7 or 8. When no stop command has been received, the process of FIG. 8 returns to step S11. When a stop command has been received, the monitoring board 5 of the first drive board 91 outputs a stop signal to the amplifier board 12 through the electrical circuit in step S13.

When the monitoring board 5 outputs the stop signal in step S13, operation of the robot 2 or the robot system 20 is stopped.

### Functions and Effects

The robot controller 1 includes the monitoring board 7 in addition to the monitoring board 5. The monitoring boards 5 and 7 monitor the robot 2 or the robot system 20 based on sensor output.

More specifically, the monitoring board 5 monitors the positions of some of the monitoring models 23 to 29, and the monitoring board 7 monitors the positions of the remaining monitoring models. Alternatively, the monitoring board 5 may monitor some of the axes of the robot 2 or the robot system 20, and the monitoring board 7 may monitor the remaining axes.

Since the task of monitoring the robot 2 or the robot system 20 is distributed among multiple monitoring boards 5 and 7, the monitoring boards 5 and 7 can monitor a large number of monitoring targets in the robot 2 or the robot system 20 even when the processing capability of the individual monitoring boards 5 and 7 is not high. Distributing the monitoring task among multiple monitoring boards 5 and 7 allows the individual monitoring boards 5 and 7 to operate without relying on high processing capability.

When the monitoring board 7 detects an abnormality, it outputs a stop command to the monitoring board 5. The monitoring boards 5 and 7 coordinate with each other to monitor the robot 2 or the robot system 20.

When the monitoring board 5 detects an abnormality, it outputs a stop signal to the amplifier board 12 through an electrical circuit. The monitoring board 5 also outputs a stop signal to the amplifier board 12 through an electrical circuit when the monitoring board 5 receives a stop command from the monitoring board 7. The monitoring board 5 can output a stop signal both when the monitoring board 5 detects an abnormality and when the monitoring board 7 detects an abnormality.

The monitoring board 5 and the amplifier board 12 are connected in hardware, and the amplifier board 12 stops the electric motors 31 in response to the stop signal output by the monitoring board 5. More specifically, the monitoring board 5 is connected to an interruption circuit located along a power supply path from the power supply board 13 to the amplifier board 12. In response to the stop signal from the monitoring board 5, a semiconductor switching element included in the interruption circuit is turned off, and power supply to the amplifier board 12 is stopped. The monitoring board 5, and the monitoring board 7 that outputs a stop command to the monitoring board 5, can meet safety standards related to the robot 2 or the robot system 20.

The first drive board 91 and the second drive board 92 are connected through communication. In other words, the monitoring board 5 and the monitoring board 7 are connected through communication. A connection through communication simplifies the connection structure between the monitoring board 5 and the monitoring board 7. A connection through communication also simplifies the connection structure between the first drive board 91 and the third drive board 93. The robot controller 1 readily accommodates the addition or omission of the monitoring boards 7, 8.

Since the I/F board 62 can be connected to the second drive board 92, the stop switch 64 can be easily connected to the monitoring board 7, or an external module can be easily connected to the monitoring board 7 via the PLC 63. The robot controller 1 offers high scalability for the monitoring function for the robot 2 or the robot system 20.

Since the robot controller 1 includes the mounts 18, the second drive board 92 or the third drive board 93 can easily be added to the robot controller 1. Since the robot controller 1 includes multiple mounts 18, multiple drive boards can be easily added to the robot controller 1. The robot controller 1 can provide a monitoring function suited to the robot 2 or robot system 20 to be controlled by changing the number of drive boards mounted on the mounts 18, that is, the number of monitoring boards.

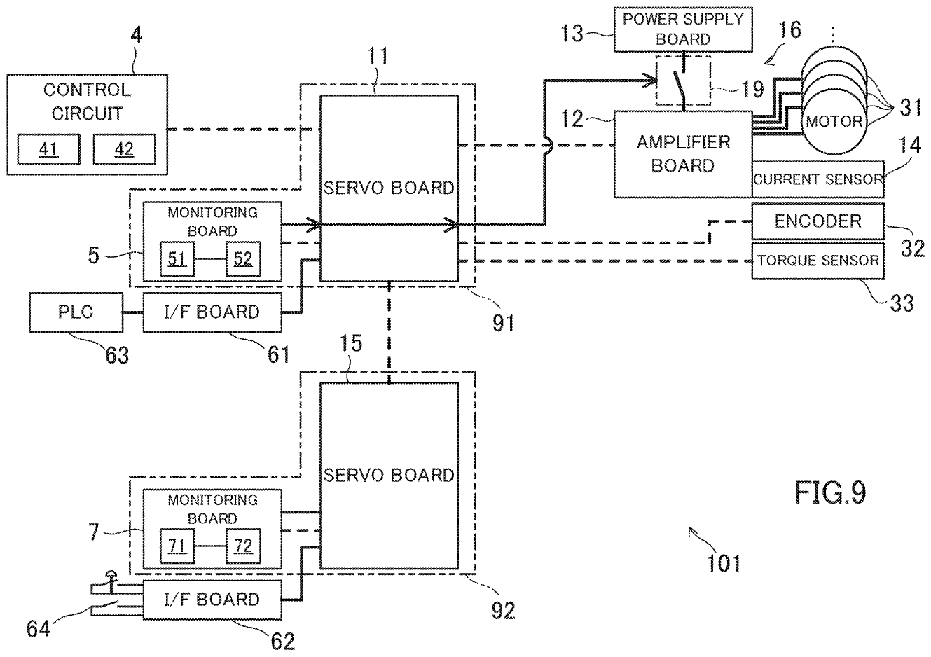

The monitoring board 5 outputs a stop signal to the amplifier board 12, and the amplifier board 12 stops the electric motors 31 or actuates their brakes. With this configuration, a contactor 19 in the modification described below (see FIG. 9) can be omitted.

### Modifications

FIG. 9 is a block diagram of a robot controller 101 according to a modification. The power supply section 16 of the robot controller 101 includes a contactor 19 as a switching element. The contactor 19 is interposed between the power supply board 13 and the amplifier board 12. The contactor 19 can electrically connect and disconnect the power supply board 13 and the amplifier board 12. When the contactor 19 electrically connects the power supply board 13 and the amplifier board 12, the amplifier board 12 can supply power to the electric motors 31. When the contactor 19 electrically disconnects the power supply board 13 and the amplifier board 12, power supply to the electric motor 31 is cut off.

The monitoring board 5 of the first drive board 91 is connected to the contactor 19 via an electrical circuit. The monitoring board 5 outputs a stop signal to the contactor 19 through the electrical circuit. Based on the stop signal from the monitoring board 5, the contactor 19 electrically disconnects the power supply board 13 and the amplifier board 12.

When the monitoring board 7 of the second drive board 92 sends a stop command to the monitoring board 5, the monitoring board 5 also outputs a stop signal to the contactor 19 through the electrical circuit in response to the stop command.

When the contactor 19 electrically disconnects the power supply board 13 and the amplifier board 12, power supply to the electric motor 31 is cut off. Operation of the robot 2 or the robot system 20 is thus stopped.

The switching element of the power supply section 16 is not limited to the contactor 19.

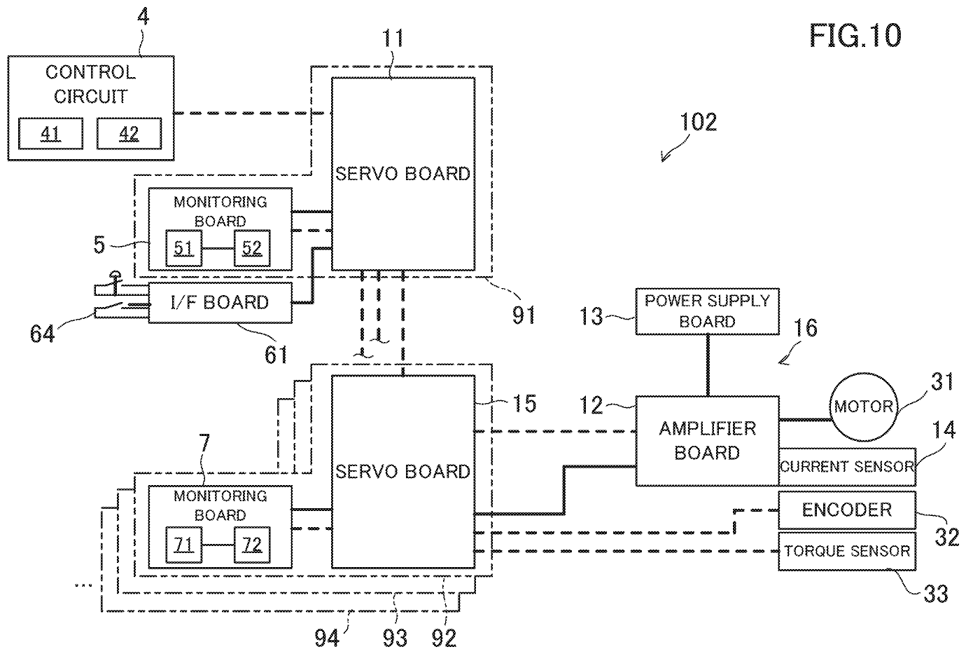

FIG. 10 is a block diagram of a robot controller 102 according to another modification. The robot controller 102 includes drive boards 92, 93, 94, and so on. Each of the drive boards 92, 93, 94, . . . corresponds to the electric motor 31 of a corresponding axis of the robot 2.

Each of the drive boards 92, 93, 94, . . . includes a servo board 15 and a monitoring board 7. In each of the drive boards 92, 93, 94, . . . , the servo board 15 and the monitoring board 7 are connected in the same manner as described above.

Each of the amplifier boards 12 also corresponds to the electric motor 31 of a corresponding axis of the robot 2. The servo board 15 is connected to the amplifier board 12 in the same manner as the servo board 11 is connected to the amplifier board 12 as described above.

The robot controller 102 includes as many drive boards 92, 93, 94, . . . and amplifier boards 12 as the number of axes of the robot 2. Each of the drive boards 92, 93, 94, . . . and each of the amplifier boards 12 may be arranged near a corresponding axis of the robot 2.

The drive boards 92, 93, 94, . . . are each connected to the first drive board 91 through communication. Upon receiving an operation command from the control circuit 4, the servo board 11 of the first drive board 91 transmits a drive command to the amplifier board 12 of each axis through a corresponding drive board 92, 93, 94, and so on.

The stop switch 64 is connected to the servo board 11 via the I/F board 61.

When the monitoring board 7 of a drive board 92, 93, 94, . . . corresponding to one of the axes detects an abnormality, that monitoring board 7 outputs a stop signal to a corresponding amplifier board 12 through an electrical circuit. Upon receiving the stop signal, the amplifier board 12 actuates the brake of a corresponding electric motor 31 or cuts off power supply to the electric motor 31. The axis corresponding to that electric motor 31 is thus stopped.

When, for example, the stop switch 64 is turned on, the I/F board 61 outputs a stop signal, and the stop signal is input to the monitoring board 5 through an electrical circuit. Upon receiving the stop signal, the monitoring board 5 outputs a stop command to the monitoring boards 7 of the drive boards 92, 93, 94, . . . for the respective axes through communication. Upon receiving the stop command from the monitoring board 5, each monitoring board 7 outputs a stop signal to a corresponding amplifier board 12 through an electrical circuit. Upon receiving the stop signal, each amplifier board 12 actuates the brake of a corresponding electric motor 31 or cuts off power supply to the electric motor 31. Operation of the robot 2 or the robot system 20 is thus stopped.

When the monitoring board 5 of the first drive board 91 detects an abnormality, the monitoring board 5 outputs a stop command to the monitoring boards 7 of the drive boards 92, 93, 94, . . . for the respective axes through communication. Upon receiving the stop command from the monitoring board 5, each monitoring board 7 outputs a stop signal to a corresponding amplifier board 12 through an electrical circuit. Upon receiving the stop signal, each amplifier board 12 actuates the brake of a corresponding electric motor 31 or cuts off power supply to the electric motor 31. Operation of the robot 2 or the robot system 20 is thus stopped.

As a modification related to the form of the monitoring board, the monitoring board may be independent of the servo board. A monitoring unit having the monitoring board may be connected to the robot controller. The robot controller is an example of a first enclosure, and the monitoring unit is an example of a second enclosure. The robot controller to which the monitoring unit is connected may or may not include a monitoring board.

Another monitoring unit may be connected to the monitoring unit connected to the robot controller. A monitoring unit directly or indirectly connected to the robot controller forms part of the robot controller.

The monitoring unit may include mounts on which monitoring boards are removably mounted. Each of the monitoring boards 5, 7, and 9 is an example of a module removably mounted on a mount.

Each of the monitoring boards 5 and 7 of the robot controller 1 may be connected in parallel to the amplifier board 12 through an electrical circuit. In other words, each of the monitoring boards 5 and 7 may output a stop signal to the amplifier board 12 through an electrical circuit. In the robot controller 101 of FIG. 9, each of the monitoring boards 5 and 7 may be connected in parallel to the contactor 19 through an electrical circuit.

The monitoring boards are not limited to monitoring different portions of the robot. A first monitoring board may monitor a first portion of the robot, for example, monitor the position of the first portion of the robot, based on a first condition, and a second monitoring board may monitor the first portion of the robot, for example, monitor a force applied to the first portion of the robot, based on a second condition.

The functionality of the elements disclosed herein may be implemented using one or more circuits or processing circuits including general-purpose processors, special-purpose processors, integrated circuits, application specific integrated circuits (ASICs), field programmable gate arrays (FPGAs), and/or conventional circuits. The functionality of the elements disclosed herein may be implemented using one or more circuits or processing circuits including combinations of general-purpose processors, special-purpose processors, integrated circuits, ASICs, FPGAs, and conventional circuits. The one or more circuits or processing circuits may be programmed using one or more programs stored together or separately in one or more memories, or may otherwise be configured to perform the disclosed functionality. A processor is considered a processing circuit or circuit because it includes transistors and other circuits. The processor may be a programmed processor that executes a program stored in memory. In the present disclosure, the circuits, units, or means are hardware that perform the recited functionality alone or in combination with one another, or hardware programmed to perform the recited functionality alone or in combination with one another. The hardware may be any hardware disclosed herein, as long as it is programmed or configured to perform the recited functionality.

A computer program including computer instructions is stored in memory. The computer instructions provide logic and routines that enable the hardware to perform the method disclosed herein. The hardware includes, for example, processing circuitry or circuitry. The computer program may be implemented in a known format in a computer-readable storage medium, a computer program product, a memory device, a record medium such as CD-ROM or DVD, and/or memory of an FPGA or ASIC.

### Aspects

The embodiment described above is a specific example of the following aspects.

### First Aspect

A robot controller (1, 101, 102) includes: a drive circuit (11) that receives an operation command from a control circuit (4) and outputs a drive command to move a robot (2, 20); a first monitoring circuit (5) that monitors the robot (2, 20) based on sensor output and, when an abnormality of the robot (2, 20) is detected, outputs a stop command to stop the robot (2, 20); and a mount (18) on which a second monitoring circuit (7) different from the first monitoring circuit (5) is removably mounted.

The first monitoring circuit (5) monitors the robot (2, 20) based on sensor output and, when an abnormality is detected, outputs a stop command to stop the robot (2, 20).

The stop command includes a voltage signal or a current signal transmitted between elements connected by an electrical circuit. The stop command also includes information transmitted between elements connected through communication.

The robot controller (1, 101, 102) includes the mount (18). The second monitoring circuit (7) can be added to the robot controller (1, 101, 102) including the first monitoring circuit (5). Since the second monitoring circuit (7) is removably mounted on the mount (18), the second monitoring circuit (7) can be easily added to the robot controller (1, 101, 102).

### Second Aspect

The robot controller (1, 101, 102) of the first aspect further includes the second monitoring circuit (7) that is removably mounted on the mount (18), and that monitors the robot (2, 20) based on sensor output, and when an abnormality of the robot (2, 20) is detected, outputs the stop command. The first monitoring circuit (5) and the second monitoring circuit (7) are connected through communication.

The second monitoring circuit (7) mounted on the mount (18) is connected to the first monitoring circuit (5) through communication. The first monitoring circuit (5) and the second monitoring circuit (7) can coordinate with each other to monitor the robot (2, 20).

### Third Aspect

The robot controller (1, 101, 102) of the second aspect further includes: a second mount (18) different from the mount; and a third monitoring circuit (8) that is removably mounted on the second mount (18), and that monitors the robot (2, 20) based on sensor output, and when an abnormality of the robot (2, 20) is detected, outputs the stop command.

In addition to the second monitoring unit (7), the third monitoring circuit (8) can be added to the robot controller (1, 101, 102).

### Fourth Aspect

The robot controller (1, 101, 102) of the second or third aspect further includes an input-output module (62) that is connected to the second monitoring circuit (7) and that receives a signal from outside. The second monitoring circuit (7) outputs the stop command when a signal from the input-output module (62) is received.

When a signal from outside is input to the second monitoring circuit (7) via the input-output module (62), the second monitoring circuit (7) can output the stop command.

### Fifth Aspect

In the robot controller (1, 101, 102) of the fourth aspect, a manual stop switch (64), or an external module (63) that outputs a stop command for the robot (2, 20), is connected to the input-output module.

When the manual stop switch (64) is turned on, the second monitoring circuit (7) outputs the stop command.

The external module (63) may be, for example, a laser scanner or a light curtain that detects the robot (2, 20) in operation. When the laser scanner or the light curtain detects the robot (2, 20), it may output a stop signal for the robot (2, 20). The second monitoring circuit (7) can output the stop command based on detection by the laser scanner or the light curtain.

### Sixth Aspect

In the robot controller (1, 101, 102) of any one of the first to fifth aspects, the first monitoring circuit (5) monitors a position of a first portion (23 to 29) of the robot (2, 20), and the second monitoring circuit (7) monitors a position of a second portion (23 to 29) of the robot (2, 20) different from the first portion (23 to 29).

The first monitoring circuit (5) and the second monitoring circuit (7) may distribute the task of monitoring the positions of different portions of the robot (2) between them. Distributing the monitoring task among multiple monitoring circuits (5, 7) allows the robot controller (1, 101, 102) to monitor a large number of monitoring targets in the robot (2, 20) even when the processing capability of the individual monitoring circuits (5, 7) is not high.

### Seventh Aspect

In the robot controller (1, 101, 102) of any one of the first to sixth aspects, the first monitoring circuit (5) monitors operation of a first actuator (31) of the robot (2, 20), and the second monitoring circuit (7) monitors operation of a second actuator (31) of the robot (2, 20) different from the first actuator (31).

The first monitoring circuit (5) and the second monitoring circuit (7) may distribute the task of monitoring operations of different actuators of the robot (2) between them. Distributing the monitoring task among multiple monitoring circuits (5, 7) allows the individual monitoring circuits (5, 7) to operate without relying on high processing capability.

### Eighth Aspect

The robot controller (1, 101, 102) of any one of the first to seventh aspects further includes an amplifier module (12) that supplies, based on the drive command, power from a power supply module (13) to an actuator (31) of the robot (2, 20). The amplifier module (12), upon receiving the stop command, stops power supply to the actuator (31) or performs braking operation of the actuator (31).

Since the amplifier module (12) stops power supply to the actuator (31) or performs braking operation of the actuator (31), the switching element (19) described later can be omitted.

### Ninth Aspect

The robot controller (1, 101, 102) of any one of the first to seventh aspects further includes: an amplifier module (12) that supplies, based on the drive command, power from a power supply module (13) to an actuator (31) of the robot (2, 20); and a switching element (19) that is interposed between the power supply module (13) and the amplifier module (12) and that electrically connects or disconnects the power supply module (13) and the amplifier module (12). The switching element (19), upon receiving the stop command, electrically disconnects the power supply module (13) and the amplifier module (12).

Since the switching element (19) electrically disconnects the power supply module (13) and the amplifier module (12), the robot (2, 20) can be stably stopped when an abnormality is detected.

### Tenth Aspect

In the robot controller (1, 101, 102) of any one of the first to ninth aspects, the first monitoring circuit (5) includes two processors (51, 52) in a redundant configuration, and the second monitoring circuit (7) includes two processors (71, 72) in a redundant configuration.

In the first monitoring circuit (5) and the second monitoring circuit (7), the two processors (51, 52, 71, 72) in a redundant configuration can monitor each other's state.

1. A robot controller comprising:
a drive circuit that receives an operation command from a control circuit and outputs a drive command to move a robot;
a first monitoring circuit that monitors the robot based on sensor output and, when an abnormality of the robot is detected, outputs a stop command to stop the robot; and
a mount on which a second monitoring circuit different from the first monitoring circuit is removably mounted.

2. The robot controller of claim 1, further comprising
the second monitoring circuit that is removably mounted on the mount, and that monitors the robot based on sensor output, and when an abnormality of the robot is detected, outputs the stop command, wherein
the first monitoring circuit and the second monitoring circuit are connected through communication.

3. The robot controller of claim 2, further comprising:
a second mount different from the mount; and
a third monitoring circuit that is removably mounted on the second mount, and that monitors the robot based on sensor output, and when an abnormality of the robot is detected, outputs the stop command.

4. The robot controller of claim 2, further comprising
an input-output module that is connected to the second monitoring circuit and that receives a signal from outside, wherein
the second monitoring circuit outputs the stop command when a signal from the input-output module is received.

5. The robot controller of claim 4, wherein
a manual stop switch, or an external module that outputs a stop command for the robot, is connected to the input-output module.

6. The robot controller of claim 2, wherein
the first monitoring circuit monitors a position of a first portion of the robot, and
the second monitoring circuit monitors a position of a second portion of the robot different from the first portion.

7. The robot controller of claim 2, wherein
the first monitoring circuit monitors operation of a first actuator of the robot, and
the second monitoring circuit monitors operation of a second actuator of the robot different from the first actuator.

8. The robot controller of claim 1, further comprising
an amplifier module that supplies, based on the drive command, power from a power supply module to an actuator of the robot, wherein
the amplifier module, upon receiving the stop command, stops power supply to the actuator or performs braking operation of the actuator.

9. The robot controller of claim 1, further comprising:
an amplifier module that supplies, based on the drive command, power from a power supply module to an actuator of the robot; and
a switching element that is interposed between the power supply module and the amplifier module and that electrically connects or disconnects the power supply module and the amplifier module, wherein
the switching element, upon receiving the stop command, electrically disconnects the power supply module and the amplifier module.

10. The robot controller of claim 1, wherein
the first monitoring circuit includes two processors in a redundant configuration, and
the second monitoring circuit includes two processors in a redundant configuration.
